(19) United States
(12) Patent Application Publication
(10) Pub. No.: US 2024/0427038 A1
(43) Pub. Date: Dec. 26, 2024

(54) COLLABORATION PLATFORM FOR SEISMIC DATA PRODUCTS AND SEISMIC DATA SERVICES

(71) Applicant: MAGSEIS FAIRFIELD AS, Oslo (NO)

(72) Inventors: Mark ZAJAC, Houston, TX (US); Michael MORRIS, Sugar Land, TX (US)

(21) Appl. No.: 18/692,385

(22) PCT Filed: Sep. 15, 2022
(86) PCT No.: PCT/NO2022/050211

§ 371 Date: Mar. 15, 2024

(30) Foreign Application Priority Data
Sep. 15, 2021 (GB) 2113202.2

(51) Int. Cl. G01V 1/00; G01V 1/30

(52) U.S. Cl. CPC G01V 1/003; G01V 1/30

(57) ABSTRACT

A collaboration platform configured to provide seismic data products and/or seismic data services using seismic sensor units is disclosed, particularly for marine seismic data products and/or seismic data services which use ocean bottom nodes to obtain seismic data. One example of the collaboration platform comprises a host or distributed hosts having one or more modules configured to receive a request for a seismic data product or seismic data service, one or more modules configured to process the received request to identify one or more workflow components comprising one or more configurable functional building blocks for executing a seismic survey or part of a seismic survey to fulfil the request using the seismic sensor units, one or more modules configured to determine one or more configuration parameters for configuring the one or more configurable functional building blocks of at least one identified workflow, one or more modules configured to generate a workflow for the requested seismic data product or seismic data service by configuring the identified building blocks using the determined configuration parameters, and one or more modules configured to execute the work-flow, wherein execution of the workflow includes retrieving data from one or more data sources including the seismic sensors, wherein execution of the workflow generates the requested seismic data product or seismic data service.

The present disclosure relates to a collaboration platform for seismic data products and services and to various related aspects, including a method of collaborating on seismic surveys for generating seismic data products and services.

Seismic exploration generally utilizes a seismic energy source to generate an acoustic signal that propagates into the earth and is partially reflected by subsurface seismic reflectors. The reflected signals (known as “seismic reflections”) are detected and recorded by seismic receivers located at or near the surface of the earth, thereby generating a seismic survey of the subsurface. The recorded signals, or seismic data, can then be processed to yield information relating to the geophysical properties of the subsurface formations.

Conducting a seismic survey involves a number of usually disparate stages. These may include, but are not limited to and not necessarily in the following order, a design stage for establishing the survey and resulting seismic image objectives (for example, to establish the area to be surveyed, the type and resolution of the seismic images, whether the seismic data will be captured by streamer or by ocean bottom node, and criteria and objectives for quality, cost and time); a planning stage to establish and secure the required physical and human resources (for example, the number and type of ships, equipment and people needed to meet the design criteria and objectives for quality, cost and time); a mobilization stage where the ship(s), equipment and people to conduct the survey are moved to the area to be surveyed; a deployment stage where the equipment to conduct the seismic survey is put into position; an data acquisition stage where the deployed equipment is used to capture and record seismic data;, a recovery stage where the deployed equipment and acquired seismic data is recovered; a demobilization stage where the ship(s), equipment and people conducting the survey are moved away from the survey area; a data assurance stage where the acquired seismic data may be checked for data quality and completeness; a data management stage where acquired seismic data may be transferred, sorted and stored; a data processing and imaging stage where the acquired seismic data is processed to generate the relevant seismic images which will ultimately be interpreted to provide information and/or make informed decisions about the subsurface formations in the surveyed area.

Various constraints and considerations may arise at each stage which may affect the timing of the processes involved and the relevance and usefulness of the outputs of that stage, which in turn may impact the order and the functions conducted with other stages.

The following provides, by way of example, some background information indicative of the complexity of designing and executing a marine seismic survey in order to generate a seismic image which provides a desired level of detail.

Seismic surveys may be conducted using seismic receivers laid out in an array, wherein the array of seismic receivers consist of a single line of receivers distributed along a pre-determined path in order to record data from the seismic cross-section below the line of receivers. For data over a larger area and for three-dimensional representations of a formation, multiple lines of receivers may be set out side-by-side, such that a grid of receivers is formed. Often, the receivers within an array or grid are remotely located or spread apart. In land seismic surveys for example, hundreds to thousands of receivers, such as geophones, may be deployed in a spatially diverse manner, such as a typical grid configuration where each string extends for many kilometers with detectors spaced every 50 meters with successive strings separated laterally. In marine surveys, a towed streamer having receivers, such as hydrophones, attached thereto may trail up to 12,000 meters behind the tow vessel.

During the data collection process, the output from each receiver is digitized and recorded for subsequent analysis. While the fundamental process for detection and recording of seismic reflections is the same on land and in marine environments, marine environments present unique problems due to the body of water overlaying the earth's surface, most notably the high pressure of deep water activities and the corrosive environment of salt water activities. In addition, even simple deployment and retrieval is complicated since operations must be conducted off the deck of a seismic exploration vessel, where external elements such as wave action, weather and limited space can greatly affect the operation.

In one common method of marine seismic exploration, seismic operations are conducted near the surface of the water body, marine vessels tow streamers in which are embedded hydrophones for detecting energy reflected back up through the water column.

The streamers are typically comprised of hydrophone strings, other electrical conductors, and material for providing near neutral buoyancy. The streamers are made to float near the water's surface. The same or other similar marine vessels tow acoustic energy sources, such as air guns, to discharge energy pulses which travel downwardly into subsurface geologic formations underlying the water.

Systems placed on the ocean bottom floor have also been in use for many years. These devices are typically referred to as “OBC” (Ocean Bottom Cable), “OBS” (Ocean Bottom Seismometer) or “OBN” (Ocean Bottom Node) systems. The prior art has centered on three main groups of ocean bottom apparatus to measure seismic signals at the seafloor. The first type of apparatus is an OBC system, similar to the towed streamer, which consists of a wire cable that contains geophones and/or hydrophones and which is laid on the ocean floor, where the detector units are interconnected with cable telemetry

A second type of recording system is an ocean bottom node, OBN, system in which a sensor package and electronics package is anchored to the sea floor. The device digitizes the signals and typically uses a wire cable to transmit data to a radio unit attached to the anchored cable and floating on the water surface. The floating transmitter unit then transmits the data to a surface vessel where the seismic data are recorded. Multiple units are typically deployed in a seismic survey.

A third type of seismic recording device is the Ocean Bottom Node (OBN), also known as a Node. These devices contain the sensors, power and electronics required to detect, record and store seismic data in sealed packages, and they record signals on the seafloor. Seismic data is retrieved from the OBN, typically by either collecting the nodes from the seafloor and downloading the data, or by wirelessly transferring data either while deployed on the ocean bottom or after node retrieval. Such nodes are typically reusable.

Some embodiments of the disclosed technology focus on an OBN type of seismic recording system. OBNs, generally include one or more various sensors (such as geophone, MEMS accelerometer and/or hydrophone), a power source, a seismic data recorder, a clock, a control circuit, and could include, a compass. With respect to the timing function of any OBS system, synchronization between the timing of the sensor data and the firing of the seismic energy source or shot is critical in order to match a seismic source event with a reflection event. A recorder workflow is used to associated timing of the sensor data with the firing of the seismic energy source or shot.

Multiple systems for performing marine ocean bottom seismic surveys are known in the art, for example, some known systems include Magseis Fairfield systems as disclosed in the U.S. Pat. Nos. 8,534,959B2, 9,360,575B2, 7,310,287B2 and 8,127,706B2, and similar systems which may be offered by competitors. Hardware and software of different systems may not be interchangeable, and each system has limitations such that balancing the differentiating requirements of different systems and how they affect each other is an example of how complex planning a marine seismic survey may be.

For example, OBN units are expensive and supply is not unlimited, so availability must be considered when planning the time and location for conducting a survey. The number of nodes required for any survey may be reduced by deploying nodes in groups and rotating those groups of nodes so that one group is deployed and recording seismic data whilst another group is being recovered from the ocean for data retrieval, QA/QC, battery replacement or recharge, and then repositioned on the ocean bottom to record acoustic signals in the next area of the survey.

While such rotation is time and manpower intensive (when compared to just dropping the units to the ocean bottom over the entire area to be surveyed and retrieving them once the survey is completed), this technique greatly reduces the number of nodes required for a given survey because only a fraction of the total survey area is covered with nodes at any time. The trade-offs for these factors and others must be considered when designing, planning and executing a seismic survey. The deployment phase of the nodes may also be challenging and affect the timing for the ultimate output of the survey. A marine seismic survey may require a system comprising hundreds or thousands of OBNs.

The deployment, retrieval, tracking, maintenance and also storage of nodes all require planning and affect the cost, timing, and effectiveness of later stages of the survey. Using a number of different tools or spreadsheets, however, leads to inefficient usage of technical resources and adds to the time it takes to configure a seismic survey once instructed. For example, customers are not able to take into account how the use of certain seismic survey equipment and their deployment may affect the timing to (and cost of) obtain a seismic data product or service. Advantageously, by providing a collaboration platform, service providers and consumers can collaboratively configure the use of equipment and other resources so these are used more efficiently. In some embodiments, the data platform allows for very large amounts of seismic data generated by a seismic surveys to be managed in a more data efficient manner as characteristics of the seismic data generated can be shared using a platform which may also provide technical information about the configuration of the survey, for example, the types of nodes used, the models and types of other equipment used to generate the data and/or what pre- and post-processing is performed on the data may also be made more transparent. In this manner, some embodiments of the data collaboration platform may be used to provide technical information about a seismic data product which is more clearly associated with the configuration of a seismic data survey.

### SUMMARY STATEMENTS

The disclosed technology seeks to mitigate, obviate, alleviate, or eliminate various issues known in the art. Whilst the invention is defined by the accompanying claims, various aspects of the disclosed technology including the claimed technology are set out in this summary section with examples of some preferred embodiments and indications of possible technical benefits.

A first aspect of the disclosed technology relates to a collaboration platform configured to provide seismic data products and/or seismic data services using seismic sensor units, the platform comprising a module configured to receive a request for a seismic data product or seismic data service, a module configured to process the received request to identify one or more workflow components comprising one or more configurable functional building blocks for executing a seismic survey or part of a seismic survey to fulfil the request, a module configured to determine one or more parameters for configuring the one or more configurable functional building blocks of at least one identified workflow, a module configured to generate a workflow for the requested seismic data product or seismic data service by configuring the identified building blocks using the determined parameters and a module configured to execute the work-flow, wherein execution of the workflow includes retrieving data from one or more data sources including the seismic sensors, wherein execution of the workflow generates the requested seismic data product or seismic data service.

In some embodiments, the first aspect of the disclosed technology comprises a collaboration platform which is configured to provide seismic data products and/or seismic data services using seismic sensor units, the platform comprising: at least one module configured to receive a request for a seismic data product or seismic data service, at least one module configured to process the received request to identify one or more workflow components comprising one or more configurable functional building blocks for executing a seismic survey or part of a seismic survey to fulfil the request using the seismic sensor units, at least one module configured to determine one or more configuration parameters for configuring the one or more configurable functional building blocks of at least one identified workflow, at least one module configured to generate a workflow for the requested seismic data product or seismic data service by configuring the identified building blocks using the determined configuration parameters, and at least one module configured to execute the work-flow, wherein execution of the workflow includes retrieving data from one or more data sources including the seismic sensors, wherein execution of the workflow generates the requested seismic data product or seismic data service.

Some embodiments of the collaboration platform is configured to allow a user such as a customer for a seismic survey generated data product or service to configure a seismic survey, for example, a marine seismic survey in an interactive manner.

Some embodiments of the collaboration platform provide interfaces to various stages of configurable and reconfigurable component workflows which are used to generate the marine seismic survey so a user can interact with and configure or reconfigure one or more of the component workflows. Assembling the component workflows may result in an end-to-end workflow which, if executed, completes a seismic survey and generates as a deliverable output the seismic data product or seismic data service requested by the user, for example, a seismic imaging data product may be output in some embodiments.

Advantageously, by aggregating information previously typically prepared in disparate systems, spreadsheets, or other proprietary tools, the collaboration platform is able to present, in some embodiments, users such as end customers with performance monitoring and oversight data through performance dashboards and other analytical tools. This may allow such users to determine one or more source(s) of anomalous data, for example, data outliers so that the anomalous data may be better corrected, discounted, or removed from any seismic data products and/or services provided via the collaboration platform in some embodiments. For example, in some embodiments, a user may be able to access meta-data comprising raw or partially processed data associated with a seismic data product such as a seismic survey image via some embodiments of the collaboration platform.

In some embodiments, the seismic sensor units are provided on marine seismic streamers.

In some embodiments, the seismic sensors are positioned on the ocean-bottom.

In some embodiments, the seismic sensors located on the ocean-bottom are arranged an array or network of ocean-floor sensors.

By way of example, references to sensors being located on the ocean-bottom may include sensors being partially or wholly embedded in the ocean-bottom, or elsewhere on an ocean or sea-floor, or in any other marine environment where seismic signals may be detectable.

In some embodiments, the sensors may be located on land in an environment where seismic signals are detectable.

In some embodiments, the seismic sensor units are configured to detect seismic data comprising data containing information about geophysical properties and geological subsurface formations obtained by applying an acoustic signal to an ocean floor and receiving a reflected signal.

In some embodiments, the seismic sensor units may be configured using the collaboration platform to process some seismic data before seismic data is retrieved from the seismic sensor units.

In some embodiments, the seismic sensor units are configured to send to the collaboration platform one of or both of on-node processed data and raw sensor collected data.

In some embodiments, the seismic data comprises active seismic data and/or passive seismic data.

In some embodiments, at least one configurable functional building block includes a control interface and a data interface via which the functional building block may be interrogated and/or configured using control information and/or configuration parameters provided in a subsequent request associated with the received request. Alternatively, the received request may include such control information and/or configuration parameters.

In some embodiments, a subsequent request comprises a request for a seismic data product or seismic data service which comprises a seismic survey workflow status update, wherein the collaboration platform is configured to respond to the request by interrogating one or more workflow components to obtain workflow status update information and shares the workflow status update information with the entity from which the subsequent request originated.

In some embodiments, the data interface allows the export of data created by at least one workflow component and/or configuration data for one or more functional building blocks of the at least one workflow component.

In some embodiments, the workflow components comprise configurable and/or reconfigurable functional building blocks for at least one or more or all of the following: a configurable and/or reconfigurable design workflow component, a configurable and/or reconfigurable planning workflow component, a configurable and/or reconfigurable source workflow component, a configurable and/or reconfigurable receiver workflow component, a configurable and/or reconfigurable navigation workflow component, a configurable and/or reconfigurable recorder workflow component, and a configurable and/or reconfigurable data assurance workflow component.

In some embodiments, the requested seismic data product or seismic data service includes seismic imaging data and/or a seismic image.

In some embodiments, executing the generated workflow comprises acquiring data for generating the requested seismic data product or seismic data service and generating the requested seismic data product or service using the acquired data.

In some embodiments, at least one workflow component comprises a recorder workflow component comprising one or more functional building blocks configured to: associate acoustic data captured by a seismic sensor unit with data capable of providing a data source signature, wherein at least one functional building block of the recorder workflow is configured to perform an integrity check on the source signature as part of the executed workflow.

In some embodiments, the seismic sensor units are ocean bottom seismic sensor units which comprise autonomous ocean bottom nodes which include an internal battery, data storage, one or more processors, and one or more sensors configured to detect seismic signals. For example, in one embodiment the one or more sensors configured to detect seismic signals comprise one or more hydrophones and one or more geophones, for example, at least one hydrophone and at least three geophones or other sensors used to measure seismic signals in some embodiments.

In some embodiments, instead of or in addition to one or more geophones a seismic sensor unit may use one or more MEMs sensors.

In some embodiments, the one or more configuration parameters for configuring the one or more configurable functional building blocks of at least one identified workflow may be provided in the request for the seismic data product or seismic data service.

In some embodiments, at least one module of the collaboration platform is configured to receive user-generated requests to configure a user-configurable seismic survey system including the seismic sensor units, and wherein at least some of the configuration parameters configuring the functional building blocks are determined based on how the system is configured using the user-generated requests.

In some embodiments, the seismic survey system is configured using the one or more user-generated requests to perform one or more or all of: deploying, retrieving, configuring, operating, and otherwise causing one or more or all of the seismic sensor units to generate the seismic sensor data.

In some embodiments, the seismic sensor data product and/or service comprises seismic sensor imaging data.

In some embodiments, the seismic sensor data product and/or service comprises seismic sensor imaging data and survey metadata.

In some embodiments, the survey metadata comprises one or more of the following data: other survey data collected from at least some of the seismic sensor units, raw seismic data collected from at least some of the seismic sensor units, partially processed raw seismic data; and partially processed seismic imaging data.

Another aspect of the disclosed technology relates to a computer-implemented method of producing a seismic data product or seismic data service using seismic sensor units, the method comprising, a collaboration platform according to the first aspect or any of the disclosed embodiments here, receiving a request for a seismic data product or seismic data service, processing the received request to identify one or more functional building blocks of a workflow required to fulfil the request using the seismic sensor units, determining one or more configuration parameters for configuring the identified functional building blocks based on one or more characteristics of the received request, generating a workflow for the requested seismic data product by configuring the identified building blocks using the determined configuration parameters and generating the requested seismic data product or service by executing the work-flow, wherein execution of the workflow includes retrieving data from one or more data sources including the seismic sensor units.

In some embodiments, the platform provides a method of collaborating on seismic surveys for generating seismic data products and services.

In some embodiments, the seismic sensor units include ocean bottom nodes and/or seismic sensor units attached to streamers.

In some embodiments, executing the workflow comprises deploying or redeploying the ocean-floor network of nodes comprising seismic sensors.

A third aspect relates to a system for producing a seismic data product or service, the system comprising an ocean-floor network of nodes comprising seismic sensors and a collaboration platform according to the first aspect of any of its disclosed embodiments.

A fourth aspect relates to an apparatus comprising memory, one or more processors, and computer program code held in the memory, wherein executing the computer program code using the one or more processors causes the apparatus to execute a method according to the second aspect or any of the embodiments of the method disclosed herein.

In some embodiments of the apparatus, the apparatus hosts a collaboration platform which may be implemented as a distributed system on a plurality of intermittently and/or permanently connected hosts.

In some embodiments of the disclosed technology in which the apparatus hosts an embodiment of a collaboration platform as disclosed herein, for example, a collaboration platform according to the first aspect or any of its embodiments disclosed herein, the apparatus may be configured with one or more data interfaces to external systems or tools. In some embodiments, the external systems or tools are configured to contribute to the delivery of the product or service, for example, by providing data used by one or more of the workflow components of the collaboration platform.

A fifth aspects comprises a computer program product which, when executed on an apparatus according to the fourth aspect causes the apparatus to implement a method according to the second aspect.

The collaboration platform of the first aspects may be configured to provide seismic data products and/or seismic data services using seismic sensor units which is particularly suitable for providing marine seismic data products and/or seismic data services which use ocean bottom nodes to obtain seismic data during a seismic survey. Some example embodiments of the collaboration platform comprise a host or distributed hosts having one or more modules configured to receive a request for a seismic data product or seismic data service, one or more modules configured to process the received request to identify one or more workflow components comprising one or more configurable functional building blocks for executing a seismic survey or part of a seismic survey to fulfil the request using the seismic sensor units. The collaboration platform may be configured with one or more modules configured to determine one or more configuration parameters for configuring the one or more configurable functional building blocks of at least one identified workflow, one or more modules configured to generate a workflow for the requested seismic data product or seismic data service by configuring the identified building blocks using the determined configuration parameters, and one or more modules configured to execute the work-flow, wherein execution of the workflow includes retrieving data from one or more data sources including the seismic sensors, wherein execution of the workflow generates the requested seismic data product or seismic data service.

A sixth aspect of the disclosed technology comprises a user-configurable seismic survey system for performing a seismic survey, the user-configurable seismic survey system comprising a plurality of seismic sensor units, one or more deployment and/or retrieval systems for deploying and retrieving the plurality of seismic sensor units, and a seismic survey collaboration platform (12) which is user-configurable to: cause the seismic sensor units to generate seismic sensor data, for example, by configuring how many shots and the shot timings which trigger the seismic activity which is detectable by seismic sensors of the seismic sensor units, receive seismic sensor data directly or indirectly from a subset or all of the seismic sensor units, process a subset or all of the received seismic sensor data to form at least one seismic sensor image of the seismic survey, wherein the at least one seismic sensor image is associated by the collaboration platform with at least part of the received seismic sensor data and/or survey meta-data for the at least part of the received seismic sensor data associated with the at least one seismic sensor image data; and output or provide access to a seismic survey data product or service comprising the at least one seismic sensor image and at least part of the received seismic sensor data and/or survey metadata to one or more users of the collaboration system.

In some embodiments, sensor data is received via a recorder system configured to obtain data from nodes, which may comprise raw sensor data or a processed version of such raw data. In some embodiments, the data received by the collaboration platform includes meta data which may include metadata from the nodes.

In some embodiments, the seismic survey collaboration platform (12) comprises a collaboration platform according to the first aspect or any of its embodiments disclosed herein.

In some embodiments of the user-configurable seismic survey system according to the sixth aspect or any of its disclosed embodiments, at least one of the one or more users receiving the output or provided with access to the seismic survey data product is a user who has used the collaboration platform to configure the seismic survey.

In some embodiments. the collaboration platform is used to configure the seismic survey by receiving a request for a seismic data product or seismic data service generated using the collaboration platform, processing the received request to identify one or more workflow components comprising one or more configurable functional building blocks for executing the seismic survey or a part of the seismic survey to fulfil the request using the seismic sensor unit, determining one or more configuration parameters for configuring the one or more configurable functional building blocks of at least one identified workflow, generating a workflow for the requested seismic data product or seismic data service by configuring the identified building blocks using the determined configuration parameters, and executing the work-flow by retrieving data from one or more data sources including data from seismic sensors of the seismic sensor units to generate the requested seismic survey imaging data product or service.

In some embodiments, the seismic sensor units are located on or above or are embedded in one or more of the following types of environment where seismic signals may be detected: a lake or river-bed, a sea floor, an ocean bottom, another type of open water or marine environment, or a land environment. For example, on land, seismic sensor units may be used in surface and subterranean environments, such as, for example, in a cave, mine, pit or shaft or the like or a surface environment, including e.g. a mountain. The sensors may also be deployed in any other environment including, for example, manufacturing environments, which may generate seismic data for seismic surveys. One example of such a use may be to monitor activities such as fracking.

Advantageously, the collaboration platform and other aspects may provide one or more technical benefits.

Some embodiments of the collaboration platform may provide a reduced total project time. For example, by integrating internal workflows with customers workflows and data processing workflows, the time it takes to design, plan and execute projects is reduced. Reducing the execution time of a seismic survey is beneficial as it frees up physical assets for subsequent survey use. In other words, increased reuse and redeployment of physical assets such as nodes, deployment and retrieval equipment, and surfaces vessels and the like, makes the use of such physical assets more time-efficient. The integration of front end processing and assurance workflows in some embodiments enables a seamless transition into data processing to reduce the time needed to process the seismic data.

Some embodiments of the collaboration platform may provide a reduced total project cost as projects may be better designed through collaboration to optimize acquisition efficiency. This may remove, a significant amount of cost from the total project budget.

Some embodiments of the collaboration platform enable the integration onboard and onshore of the data processing workflows. This may save not just costs but processing and energy resources as rework may be reduced or eliminated which otherwise occurs between the data processing centers which receive seismic imaging data and the field assurance and processing operations.

Some embodiments of the collaboration platform may be used to provide customers with interactive dashboards that provide live and/or off-line operational oversight, the customers are able to monitor their projects remotely to enable faster operational decision making during the acquisition phase of the project and further reducing their operational costs.

Another technical benefit of using some embodiments of the data collaboration platform is a reduced time to image.—For example, some embodiments of the data collaboration platform provide access to intermediate imaging deliverables. This provides access to technical information which can be used to improve the final imaging deliverable. Access to the final processed data volumes may also be provided in some embodiments of the collaboration platform. By providing access to the intermediate as well as the final imagining data deliverables more visibility and choice of pre- and post-processing techniques may be provided in some embodiments. In some embodiments, the data collaboration platform allows onboard workflows to be automated and the field deliverables integrated with the data processing workflows to reduce the time it takes to deliver the final data volume to the requesting party. Some embodiments of the collaboration platform according enables customers to realize more value from projects by providing access to the intermediate imaging deliverables and the final processed data volumes, onboard workflows can be automated and the field deliverables integrated with the data processing workflows to reduce the time it takes to deliver the final data volume to the requesting party. Another advantage provided by some embodiments of the collaboration platform is increased mobilization and demobilization efficiency. In other words, the efficiency of deploying nodes for and their retrieval after seismic surveys may be improved as there is more visibility of the equipment and personnel required to do this.

Some embodiments of the data collaboration platform provide project design and planning phases of workflows used to determine the resources needed for the acquisition planning. Mobilization and demobilization activities add significant costs and time to the project. Some embodiments of the data collaboration platform provide a modular, mobile and scalable solution which allows seismic data products to be provided by operations which are configured for efficiency both of time and resources while offering our customers the flexibility needed to optimize their project. Some embodiments of the collaboration platform may enable higher data quality seismic survey data products to be provided. Some embodiments of the collaboration platform provide safe and operationally efficient services with good quality of the seismic data. In some embodiments, the collaboration platform provides systems and processes which can be configured to provide a desired level of quality of the seismic data. In some embodiments, the collaboration platform can be used to configure systems and processes for implementing a seismic survey in a way that ensures the best possible quality of seismic data generated in any operational environment, is collected and delivered. In some embodiments, the seismic data is generated using a nodal system, which, for example, may comprise a nodal system such as the Magseis MASS I, MASSIII or Z nodal systems in some embodiments. These node designs are used with coupling consistency and vector fidelity which have clock synchronization processes to ensure timing consistency over extended periods of bottom time. Some embodiments of the collaboration platform enable seismic surveys to be conducted in a more repeatable manner.

To exploit resources in a reservoir fully requires the highest level of repeatability on a 4D program. The collaboration platform enables analysis of node and source positions, performance, and quality metrics over defined time periods to eliminate perturbations in the seismic data due to positioning uncertainty and source variation.

The collaboration platform provides a next generation OBN technology platform which allows customers to engage throughout the entire design to decisions value stream. The interactive nature of the collaboration platform allows a customer's knowledge to be brought into the design and planning phases of a survey project and allows them to interact with the workflow processes throughout the project. During project execution, the interactive desktop portal allows a customer to monitor progress and provide operational oversight throughout the project execution.

The disclosed aspects and embodiments may be combined with each other in any suitable manner which would be apparent to someone of ordinary skill in the art.

### BRIEF DESCRIPTION OF THE DRAWINGS

Some embodiments of the disclosed technology are described below with reference to the accompanying drawings which are by way of example only and in which:

FIG. 1 schematically illustrates a collaboration system according to some embodiments of the disclosed technology;

FIGS. 2A to 2D show an example of an overall flow of data from contract award to delivery which may be managed using the collaboration platform in some embodiments;

FIG. 3A shows schematically an example of a collaboration platform according to some embodiments of the disclosed technology;

FIG. 3B shows schematically another example of the collaboration platform according to some embodiments of the disclosed technology;

FIG. 4 illustrates schematically an example of a method of using a collaboration platform according to any of the disclosed embodiments to generate a seismic data product and/or seismic data service; and

FIG. 5 illustrates schematically an example of a host apparatus for some of the disclosed embodiments of the collaboration platform.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Steps, whether explicitly referred to a such or if implicit, may be re-ordered or omitted if not essential to some of the disclosed embodiments. Like numbers in the drawings refer to like elements throughout.

The terminology used herein is for the purpose of describing particular aspects of the disclosure only, and is not intended to limit the disclosed technology embodiments described herein. As used herein, the singular forms “a”, “an” and “the” are intended to include the plural forms as well, unless the context clearly indicates otherwise. The use of terminology expressed as “x and/or y” refers to both “x and y” or “x” or “y”.

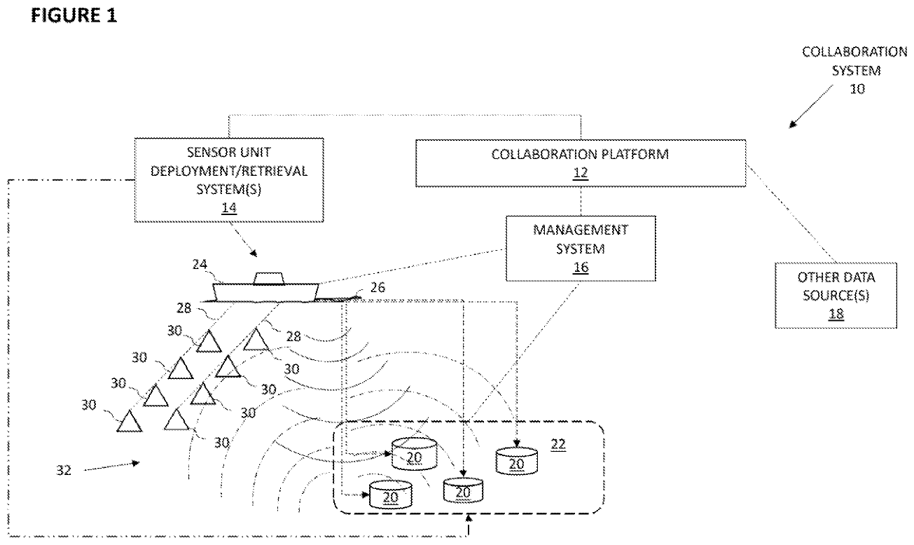

FIG. 1 schematically illustrates a collaboration system 10 according to some embodiments of the disclosed technology. The collaboration system 10 comprises a collaboration platform 12 configured to generate an end to end workflow which allows users to interactively engage with design, planning, source, receiver, navigation, recorder, and data assurance stage workflow components. In some embodiments, the end-to-end workflow covers all stages which are executed from a contract award, and in some embodiments, even prior to a contract award, for performing a seismic survey to the delivery of seismic imaging data or of the image(s) which seismic imaging data may be used to generate. The end-to-end workflow is executed by configuring a number of collaborative workflow components focused on the above stages.

Users who provide instructions, also referred to herein as instructing entities, to the collaboration platform 12 are able to interact with the various workflow components required to fulfil a request for delivering a seismic data product or seismic data service. An example of a seismic data product is imaging seismic data which may be processed, either within the framework of the collaboration platform by using a suitable data processing workflow component, or externally by a third party, to generate a seismic image, for example in 3D or 4D, for a specified surveyed area.

The term seismic data refers herein to data derived from one or more seismic surveys in contrast to seismic data which is generated by monitoring for earthquakes and detecting the seismic activity that an earthquake may directly or indirectly cause. More specifically, the term seismic data as used herein refers to data which includes data containing information about geophysical properties and geological subsurface formations, obtained by applying an acoustic signal to the ground and receiving the reflected signal. In particular, the term seismic data refers to data containing information about geophysical properties and geological subsurface formations obtained by conducting a marine seismic survey, such as may be performed using the collaboration system shown schematically in FIG. 1.

In some embodiments, the collaboration system 10 shown in FIG. 1 may be configures to that it can be used instead to generate workflows which are used instead for land seismic surveys or for towed marine seismic surveys.

In FIG. 1, the collaboration platform 12 is configured to communicate with a number of collaboration system components, including a seismic sensor unit deployment and/or retrieval system 14, for example, located on one or more surface vessels 24 on the ocean surface for retrieving and/or deploying sensor nodes such as nodes 20 or 30 shown in FIG. 1.

In some embodiments of the collaboration platform 12, workflows may be generated for surveys where instead or in addition to being deployed from a surface vessel 24, one or more or all of the nodes are deployed from autonomous underwater vehicles (AUVs). In some embodiments, it may be possible to generate a workflow where one or more or all of the nodes 20,30 are instead or in addition deployed from and/or retrieved to some other type of underwater node storage/deployment facility.

In the embodiment of the collaboration system shown in FIG. 1, the collaboration platform 12 is also configured to communicate with a seismic sensor unit management system 16 which may be located on the same or on different surface or sub-surface vessels 24 and/or be provide on-shore or in a sub-sea facility depending on the particular management regime in use.

In some embodiments the collaboration platform 12 may be used to configure workflows for generating a seismic data product using seismic sensor systems comprising ocean bottom nodes 20 and/or streamer nodes 30. The collaboration platform 12 is configured to also configure the workflows based on a planned or actually used a node handling system such as the sensor unit deployment/retrieval system 14 shown provided on a surface vessel 24 in FIG. 1.

The collaboration system may also be used to perform one or more of reserving, deploying, and/or operating one or more remotely operated vehicles, ROVs, that places the OBNs 20 on the seabed may be used. Some embodiments of the node handling system may instead or additionally use AUVs to place OBNs 20 on the ocean bottom. The seismic sensor deployment and/or retrieval system 14 shown schematically in FIG. 1 as comprises a node handling system and the ROV may be instead referred to as a deployment/recovery system 14, which is not located on a surface vessel.

Also shown in FIG. 1 are other data source(s) 18 which provide data to the collaboration platform 12. In some embodiments, other components, not shown in FIG. 1, of the collaboration system 10 are provided, for example on-board and/or on-shore data storage facilities may be utilized instead or in addition to data being stored by the collaboration platform 12 itself. The collaboration platform 12 may be provided in a distributed or standalone manner, for example, it may be provided as a cloud based service in some embodiments.

In some embodiments, the collaboration platform 12 is configured, for example, to enable a survey instructing entity to also interrogate and in some embodiments interact with the deployment/retrieval systems 14 to obtain seismic sensor unit deployment and/or retrieval status updates and/or adjust the deployment/retrieval operation parameters in a planning phase for the survey. The collaboration platform 12 is configured, in some embodiments, to allow a survey instructing entity or other user of the collaboration system to specify the nature of the seismic sensor units to be used in the survey as well as deployment/retrieval characteristics. For example, seismic sensor units may be provided in ocean bottom nodes 20 in some embodiments, for example, an array or network 22 of such ocean bottom nodes 20 may be used to detect acoustic signals fired from an air gun by a surface such as surface vessel 24 shown in FIG. 1 (the acoustic fired signals and their reflections are shown by solid and dot-dashed arcuate lines respectively in FIG. 1).

Alternatively, or in addition, seismic sensor units 30 may be arranged in a suitably spaced configuration along a plurality of streamers 28 which are streamed in the sub-sea surface marine environment 32 from a surface vessel such as from the vessel 34 shown in FIG. 1.

The acoustic signals detected by either type of seismic sensor unit 20 or 30, may be reflected off geological features on or below the ocean bottom in some embodiments, however, the acoustic signals are also used to measure stratigraphy as well. As used herein, lithographic refers to physical properties of rock whereas stratigraphy is the layering of sediments and both are measured. In some embodiments, it's the stratigraphic layers which are measured and the rock properties are derived from the seismic data/images. It is the reflected acoustic signals detected using the plurality of seismic sensor units 30 which are attached to streamers 28 trailed from the vessel 24 on the ocean surface 26 and/or which are detected by the plurality of sensor units 20 which are positioned on the ocean bottom, also referred to herein as ocean bottom nodes, OBNs.

The collaboration platform 12 may also be provided with an interface to allow a survey requesting entity or other user to configure the management system 16 to manage the seismic sensor units 20, 30. For example, a user may use the collaboration platform 12 to specify when maintenance should be performed by lifting OBNs 20 and/or whether the OBNs 20 should be recharged if they are battery powered.

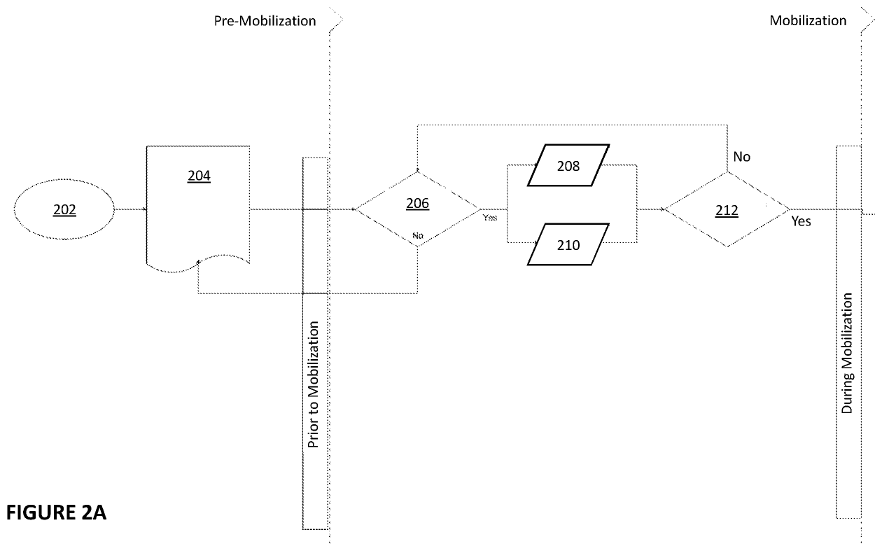

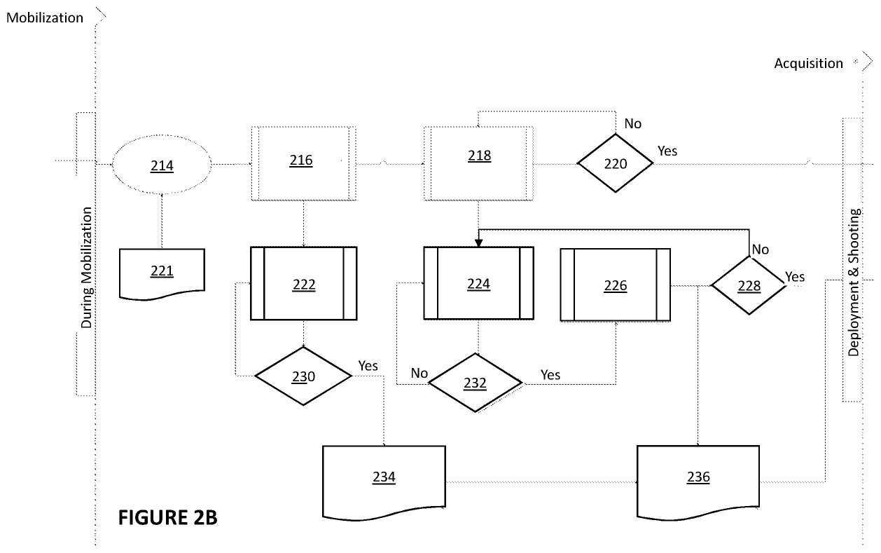

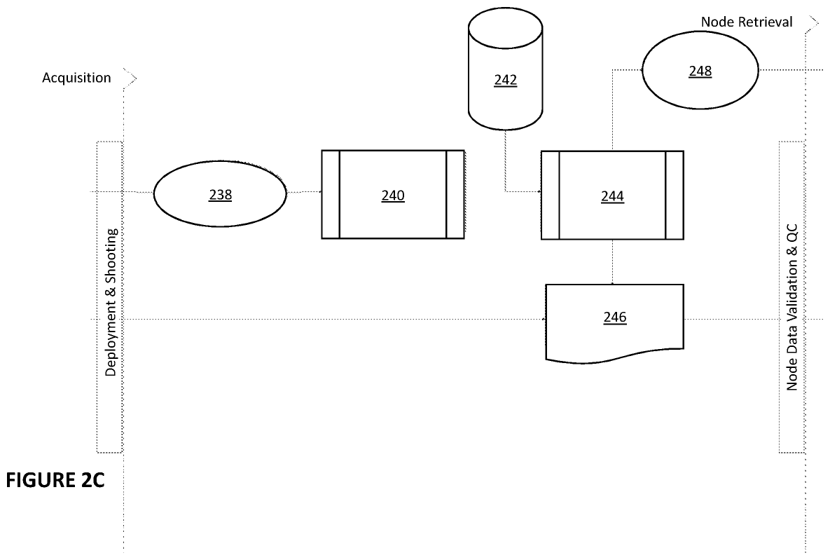

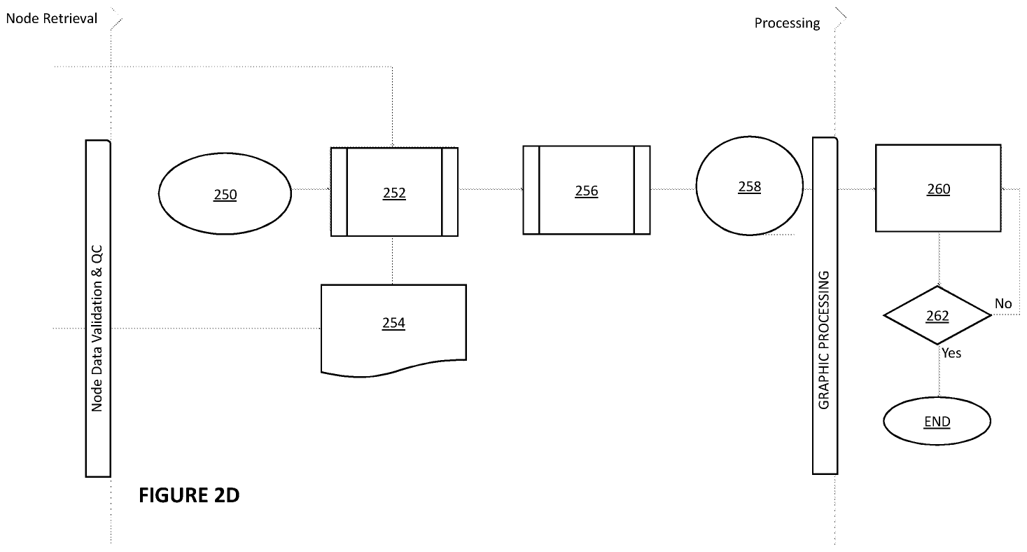

FIGS. 2A to 2D show an example of an overall flow of data from contract award to delivery of a seismic data product or seismic data service which may be managed using the collaboration platform in some embodiments.

In FIG. 2A, the data flow begins with a pre-mobilization phase for a marine seismic survey in which a contract is awarded 202 and a project execution plan, PEP, is generated in 204 comprising processing flows, processing deliverables, tolerances and specifications, a data acquisition plan, and recording system settings. Once the PEP has been approved in 206, a mobilization phase starts which mobilizes the necessary resources and equipment to conduct the requested survey based on the approved PEP in which shot pre-plots 208 and receiver pre-plots 210 are obtained and once these pre-plots are approved 212, deployment and acquisition are started 214 (see FIG. 2B) according to the project execution plan (206), shown as 221 in FIG. 2B.

In the example of a data work flow shown in FIGS. 2A to 2D, the seismic sensor units may comprise seismic sensor units 20, 30 shown in FIG. 1 for example, in some embodiments, nodes 20, 30 may include ocean bottom nodes, or OBNs, 30 which are deployed by executing a node deployment process 216 as shown in FIG. 2B. The node deployment 216 may also be part of a node navigation processing and related quality check on the node and/or data 222.

In FIG. 2B, after node deployment, a shooting process 218, i.e. the firing of air guns or similar activation of acoustic signal sources takes place once the nodes 30 are in position and once shooting is complete in 220 the process continues in a data acquisition phase.

During the deployment and shooting phase shown in FIG. 2B, however, the shooting process 218 also involves source navigation processing 224 which performs quality control/quality checks, QC, to be performed at the completion of every source line. If the source QC is determined to be good meaning at least sufficient quality conditions are met so the quality is acceptable in 232, then a shot table verification process is performed in 226. If all fired sources are verified in 228 the workflow process is deemed to be executing as expected in other words everything is fine and the process shown in FIG. 2B moves on with several reports being generated in 236. For example, one or more or all of a source performance report, a shot line report, and a shot table report, and a production status report may be created in some embodiments of the reports generated in 236.

These reports may also include data from the node navigation workflow which performs node navigation processing and quality control/checks in 222. If the node navigation quality check is acceptable in 230, the workflow data may be processed to generate node deployment notes in 234. One example of a deployment note is a note which indicates in 234 whether a node was skipped, missed, redeployed, or moved during deployment. This information can then be included in one or more or all of the reports generated in 236 as appropriate. The reports may be output to a user in some embodiments by the collaboration platform 12, for example, a message may be sent containing the report or a link to the report. In some embodiments, instead or in addition the collaboration platform may store the report information so it may be accessible to a user of the collaboration platform. In some embodiments, and as shown in FIGS. 2B and 2C, one or more of all the information generated in 236, for example, for the file load report, the shot line report, the shot table report, and the production status report, may also be used or contribute to the information used to generate a preliminary station log 246 which in turn forms part of all the acquisition documentation in 254. Some or all of the acquisition documentation generated in 254 may be made accessible to users via the collaboration platform in some embodiments.

FIG. 2C shows schematically how after the deployment and shooting phase has completed, a data acquisition phase commences in which the acoustic signals detected and recorded by the seismic sensor units or nodes 20 start to be retrieved in 238. The data acquired is downloaded by retrieving, for example, a node and downloading the data off it in a node retrieval & download process 240.

Next a node verification and quality control check is performed in 244 using a node system database 242, for example, the nodal system database indicated by the label FFN Z system database shown in FIG. 2C. The node verification and quality control process 244 may also output or cause to be stored and made accessible to a user of the collaboration platform in 248, a file or files or other type of computer data storage structure including a structure on physical media such as a tape or disc or other form of memory drive, for example, a USB drive, or the like containing client defined data in 246. In some embodiments of 246, the node verification and quality control generates a preliminary station log including all acquisition and data quality notes, flagging nodes for follow-up etc.

In some embodiments, the data generated by the node verification and quality check in 244 which is stored and sent or otherwise made accessible to a user such as a client or customer may use user-defined-(for example, customer or client-defined) fields for the data. The configuration of such fields may be provided by such users via the collaboration platform in some embodiments. The data 248 is then read and verified in 252 of FIG. 2D in some embodiments and provided to the acquisition documentation in 254 as well as being used to generate QC products and process data in 256.

FIG. 2D shows schematically how the node data verification and quality control phase has been completed, an on-board data processing phase which allows graphic processing to start in 260 of the data starts in 250. In this case, the data and/or files provided by the previous node data verification and quality control phase is read and a verification process performed in 252 which may also use the acquisition documentation obtained in the node data 254 and/or verification & quality control phase information from the preliminary station log generated in some embodiment of 246 shown in FIG. 2C.

The tape read and verification QC phase indicated in FIG. 2D may use tape media but in practice it may use other data storage media. Historically seismic data was written to a tape media and transferred to the consumers by tape due to the high volumes of data which need to be transferred. More recently, one or more other forms of tangible data storage such a storage disc, flash drive, and/or other suitable form of data storage, including sending data to remote storage on cloud based storage systems may be used in practice, and where tape is referred to this should be interpreted as referring to any suitable data storage device or system.

The tape read and verification QC phase is followed by an on-board processing phase in which the final deliverable packaging is generated in 260, for example, by a quality controlled products and process data phase 256 which may output a seismic data product or a seismic data service deliverables from 258 in the form of such as tape, data, or some client defined data set, for example, a SEG-Y dataset. The SEG-Y (sometimes SEG Y) file format is one of several standards developed by the Society of Exploration Geophysicists (SEG) for storing geophysical data. SEG-Y is an open standard, and is controlled by the SEG Technical Standards Committee.

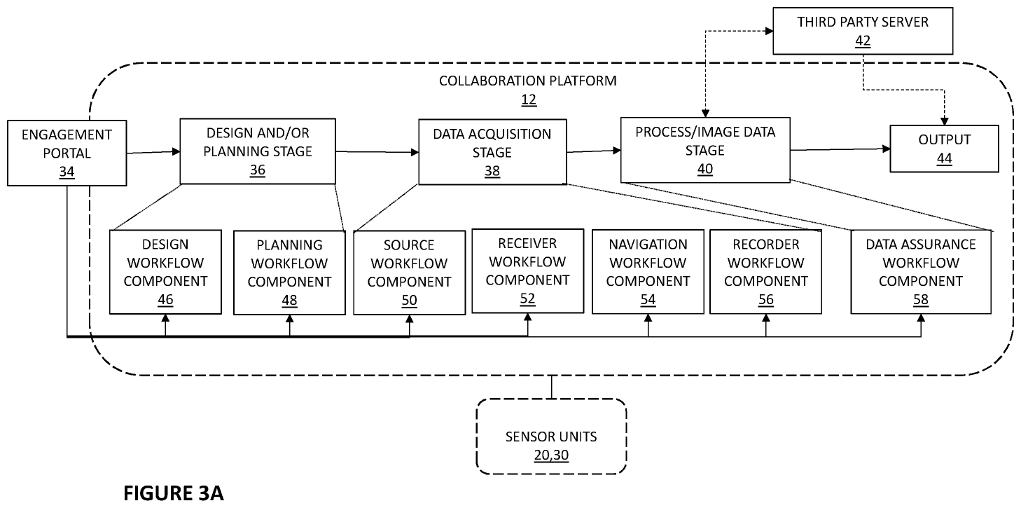

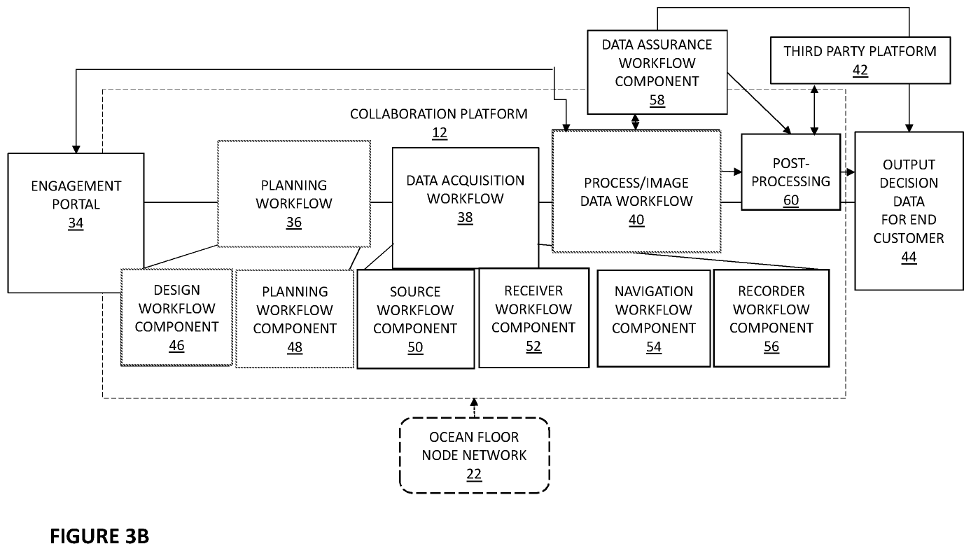

Once the on-board processing phase has completed, the final deliverable from 260 is output to its destination or made available on the collaboration platform. Once delivery has been verified in 262, the example data workflow process for this particular example of a seismic data product ends on the collaboration platform. The disclosed embodiments of the collaboration system and collaboration platform 12 shown in FIG. 1 are configured to manage the complexity of the end to end data flow shown in FIGS. 2A to 2D in a way that allow survey instructing entities and other users to build a customized end to end workflow from one or more workflow components which they may be able to customize by providing relevant information such as workflow configuration parameters and characteristics in the request and/or for the workflow output. FIG. 3A shows schematically an example of a collaboration platform 12 according to some of the disclosed embodiments. In the example embodiment of the collaboration platform shown in FIG. 3A, the collaboration platform 12 is provided with an engagement portal 34 via which instructions to configure a marine seismic survey can be received either directly from a user or indirectly in the form of a desired survey output, for example, an image resolution to cover an area to a particular depth may be specified in the request in some embodiments. The engagement portal 34 may be hosted in the cloud or provided by a distributed system of servers which host some or all of the collaboration platform in some embodiments. It may also be hosted on a dedicated engagement server of the collaboration platform in some embodiments.

As shown in FIG. 3A, a workflow provided by the collaboration platform comprises a number of workflow components 46 to 58 which may be assembled into an end-to-end workflow so that a process a seismic survey data deliverable can be implemented. An example of how such an end-to-end workflow can be implemented is shown in FIGS. 2A to 2D.

Some examples of an embodiment of an end-to-end workflow comprise at least workflows relating to a marine seismic survey design and/or planning phase 36 such as may be provided by a design and planning workflow 36 as shown in FIG. 3A, a marine seismic data acquisition phase workflow 38 and a marine seismic data processing phase workflow 36, and a processing/image generating stage workflow 40 which collectively allow a deliverable output 44 to be generated. An example of deliverable output 44 comprises a seismic survey data deliverable such as seismic survey imaging data. The output 44 may be sent to one or more external, in other words, third party servers such as third party server 42 as shown in FIG. 3A in some embodiments and/or made accessible to one or more users/other servers via the collaboration platform itself. In other words, in some embodiments, the collaboration platform may store the data deliverables for access by third party users.

By way of example, collectively in some embodiments, a user can use the end-to-end workflows 36, 38, in conjunction with an image data/data processing workflow stage 40, and possibly one or more intermediate or post-processing of preliminary imaging data which may be configured/implemented using a post-processing component 60 as shown in FIG. 3B to generate seismic imaging data from seismic sensor data.

In some embodiments, the seismic imaging data is provided directly as a deliverable output to a third party 42 as shown in FIG. 3A however it may be post-processed further using the platform in some embodiments of the platform such as that shown in FIG. 3B.

As shown schematically in the embodiments of FIGS. 3A and 3B, the process/image data workflow 40 and/or post-processing workflows 60 may be used to process seismic imaging data to generate a seismic image as a data deliverable to one or more users of the collaboration platform such as a seismic survey requesting entity or other nominated party. Such parties may access the seismic image data either via the engagement portal 34 or via some other type of data interface with a third party platform 42.

In some embodiments, however, the seismic output 44 instead or in addition includes a seismic image generated by the collaboration platform directly. For example, a low resolution image may be provided or otherwise made available to the requesting entity via engagement portal 34. Also shown in FIG. 3A are a plurality of workflow components 46 to 58 which may be used to generate a customized workflow responsive to a survey request or one or more other subsequent request associated with a previous survey request received via the engagement portal 34. As shown in FIGS. 3A and 3B, such a request may comprise configuration parameters and values for one or more or all of the workflow components shown as design workflow component 46, planning workflow component 48, source workflow component 50, receiver workflow component 52, navigation workflow component 54, recorder workflow component 56, and a data assurance workflow component 58.

Advantageously, in some embodiments, the collaboration platform may store the configuration parameters and values for the workflow components and make these available for reuse when planning subsequent seismic surveys. Some embodiments of the collaboration platform accordingly allow a user to edit stored seismic survey configuration parameters and values.

The collaboration platform 12 is also configured to receive data directly or indirectly from seismic sensor units 30 provided on streamers 28 and/or from OBNs 20 on the ocean floor. In some embodiments, the OBNs 20 may form an ocean bottom node network 22.

Some example embodiments of the collaboration platform 12 shown in FIGS. 1, 3A, and 3B are configured to provide seismic data products and/or seismic data services using seismic sensor units 20, 30. The collaboration platform 12 may comprise a module configured to receive a request for a seismic data product or seismic data service, a module configured to process the received request to identify one or more workflow components comprising one or more configurable functional building blocks for executing a seismic survey or part of a seismic survey to fulfil the request using the seismic sensor units, a module configured to determine one or more configuration parameters for configuring the one or more configurable functional building blocks of at least one identified workflow, a module configured to generate a workflow for the requested seismic data product or seismic data service by configuring the identified building blocks using the determined configuration parameters, and a module configured to execute the work-flow, wherein execution of the workflow includes retrieving data from one or more data sources including the seismic sensor units, wherein execution of the workflow generates the requested seismic data product or seismic data service.

One or more or all of the modules of the collaboration platform 12 may be configured in hardware, for example, memory and/or circuitry and/or software. In some embodiments, one or more or each module may comprise a physical component or device of the collaboration platform storing executable instructions as computer-code in a suitable form of memory.

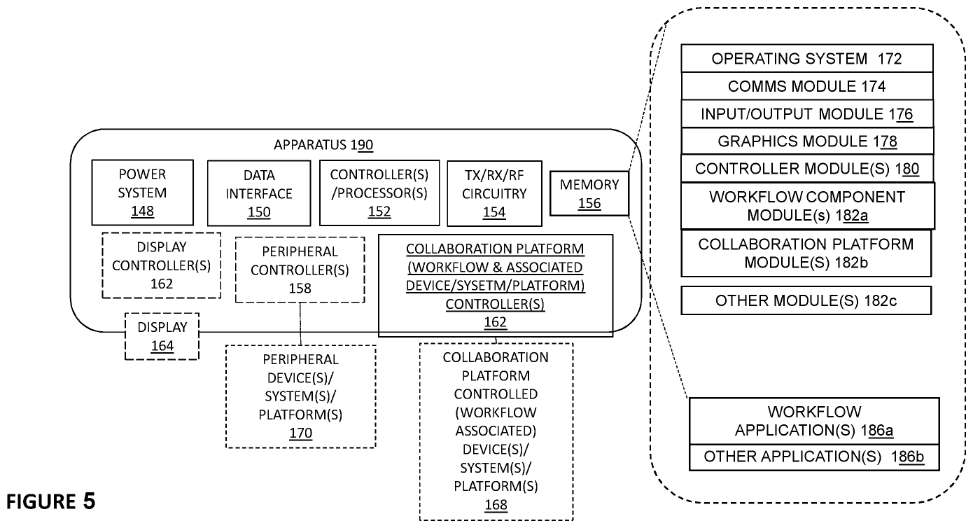

The computer code which forms a module may, in some embodiments, be loaded from memory and executed by one or more processors or control circuitry of apparatus to configure the apparatus to host an embodiment of a collaboration platform according to any of the embodiments disclosed herein. The modules may be configured to work with one or more processors and/or controllers of a host apparatus 200 such as a host server or server system on which the collaboration platform is implemented and may also work with other components of the host apparatus 200. See FIG. 5 for an example of a host apparatus 200 which may be configured to function as a collaboration platform 12. The functionality of each module may in some embodiments be at least partially implemented using one or more of the other modules of the collaboration platform. In some embodiments, the collaboration platform may be implemented by apparatus which provides cloud based host(s) or it may be implemented by apparatus which comprises several suitably connected physical hosts in other. In some embodiments, instead, the collaboration platform may be implemented by apparatus forming a stand-alone server.

Examples of other data sources 18 which may be included in the collaboration system 10 but which may be external to the collaboration platform 12 include one or more data repositories and/or external data processing platforms, such as may be used to generate seismic images. Artificial intelligence, AI models or machine learning, ML, models may be used to interpret the images in some embodiments.

The request may be received by the collaboration platform 12 via an engagement portal 34 for external parties such as that shown in FIGS. 3A and 3B. For example, an interactive desktop portal may be provided to allow a customer to monitor progress and provide operational oversight throughout the project execution. The request may generated during the design or planning stage (premobilization) or later in the survey's end to end workflow. Later requests may be associated with earlier requests using a suitable mechanism, for example, each request which is being processed may be provided with an identifier and subsequent related requests may only be accepted if they can be associated with the identifier for the earlier request. In some embodiments, the subsequent request may be provided whilst the earlier request is being processed.

The configuration parameters received in a request may be provided explicitly or implicitly. In some embodiments at least one configuration parameter is based on one or more characteristics of requested seismic data product or service. For example, a desired resolution of a seismic image, information indicating the survey area, what kind of seismic image is wanted. These characteristics may affect the design and planning stage workflows as they may affect the density of the seismic units 20, 30 and the frequency of shots fired. A request may also include data or information such as geological features of subsurface which could impact the execution of the requested survey.

For example, a source configuration adjustment and/or a sensor configuration adjustment may be performed to optimize useful seismic data obtained from the survey, for example, if the survey area includes a geological feature such as a salt dome, the survey may be conducted with a different node spacing than which would be used if no such feature existed. In some embodiments, accordingly, information on the geologic subsurface provided in the received request directly or indirectly provide characteristics of the request which are used to configure the design workflow component and/or execution of the survey to, for example, include wide azimuth shooting. In some embodiments, accordingly, the collaboration platform allows a user to adjust node density in a particular geographic location. The node density adjustment may be performed automatically in some embodiments depending on how a user has configured the survey if, for example, there is data which indicates there is a geological feature of interest in a particular location.

In some embodiments, the seismic sensor units comprise nodes or units 30 are provided on marine seismic streamers 28. In some embodiments, the seismic sensor units comprise nodes 10 positioned on the ocean-bottom, which may also be referred to as the sea-bed. In some embodiments, a seismic sensor node 20 referred to as positioned on the ocean-bottom or sea-bed may in fact be partially or wholly embedded in the ocean-bottom or suspended slightly above it.

In some embodiments, the seismic sensors located on the ocean-bottom are arranged an array or network 22 of ocean-floor seismic sensor systems. In some embodiments, the seismic sensors may be located on streamers towed from a vessel.

In some embodiments of the collaboration platform 12, the seismic sensor units 20, 30 are configured to detect seismic data comprising data containing information about geophysical properties and geological subsurface formations, obtained by applying an acoustic signal to an area of ground such as an area of ocean floor and receiving the reflected signal.

In some embodiments, the seismic data comprises active seismic data and/or passive seismic data.

In some embodiments of the collaboration platform 12, a functional building block of a workflow component, for example one of the workflow components 46, 48, 50, 52, 54, 56, 58 illustrated schematically in FIGS. 3A and 3B, is configurable or reconfigurable using data received via the data interface and/or the control interface.

In some embodiments of the collaboration platform 12 shown in FIGS. 3A and 3B, at least one configurable functional building block illustrated as a workflow component 46, 48, 50, 52, 54, 56, 58 includes a control interface and a data interface via which the functional building block may be interrogated and/or configured using control information and/or configuration parameters provided in a subsequent request associated with the received request.

In some embodiments, at least one workflow component provides supports workflow functional building block 46, 48, 50, 52, 54, 56, 58 is configured to allow external interaction and customization of the workflow. This allows for monitoring and/or operational oversight for users of the coloration system for how the workflow is progressing/executing.

In some embodiments of the collaboration platform, a subsequent request comprises a request for a seismic data product or seismic data service which comprises a seismic survey workflow status update, wherein the collaboration platform is configured to respond to the request by interrogating one or more workflow components to obtain workflow status update information and shares the workflow status update information with the entity from which the subsequent request originated.

In some embodiments, the data interface allows the export of data created by at least one workflow component and/or configuration data for one or more functional building blocks of the at least one workflow component.

In some embodiments of the collaboration platform 12, the workflow components comprise configurable and/or reconfigurable functional building blocks for at least one or more or all of the following: a configurable and/or reconfigurable design workflow component, a configurable and/or reconfigurable planning workflow component, a configurable and/or reconfigurable source workflow component, a configurable and/or reconfigurable receiver workflow component, a configurable and/or reconfigurable navigation workflow component, a configurable and/or reconfigurable recorder workflow component, and a configurable and/or reconfigurable data assurance workflow component.

In some embodiments of the collaboration platform 12, one or more or each of the workflow components is configured with a control and/or data interface which enables an external survey requesting entity or other user of the collaboration platform to adjust the configuration parameters used by that workflow component to generate an end-to-end workflow for executing a seismic survey. This allows, for example, the external entity or other user to interrogate the status of one or more of the component workflows and/or to iterate back and forth with configuration parameters and outcome characteristics. This is particularly beneficial to users who wish to understand how one or more adjustments to a workflow component's configuration and characteristics of the desired survey output(s) may impact the time taken to obtain the survey output, in other words, for that user to obtain any deliverables, and how this could affect timing, cost and logistical planning etc.

In some embodiments, the planning workflow includes planning for deploying or redeploying the ocean-floor network 22 of nodes 30 comprising seismic sensors.

In some embodiments, the design workflow component 46 of FIGS. 3A or 3B includes one or more configurable functional building blocks, for example functional building blocks which can be configured by a user via engagement portal 34, to configure the design of the seismic survey from which a seismic data product will be generated. For example, in some embodiments, the design workflow component may be used to configure one or more of: a total area to be surveyed and the depth of each planned survey, how long will the planned survey be conducted for, how big is the area to be covered with each seismic sensor deployment, for example, if the area planned to be surveyed using a node roll technique or not, and if so, the size of each node roll, the size of the total area, the location of the survey, the type of outputs required from the collaboration survey, for example, the resolution of any requested imaging data and/or image to be generated from the data.

In some embodiments, the planning workflow component 48 may be used to configure a seismic survey by allowing a user to indicate, for example, by engagement portal 34, one or more of: how many nodes will be required to provide the requested output, what density of nodes may be required, for example, a higher node density may result in a higher image resolution, if the acoustic signal sources are known, how the seismic sensor units should be positioned, and one or more other characteristics of the survey operation, for example, the type of deployment platform 14 which may be surface vessel 24 or a different vessel and/or a remote operated vehicle, RoV, capable of underwater deployment of seismic units on the ocean bottom.

Other characteristics such as the speed of the vessel 24 and firing rate may be planned as well as these can affect the spacing between seismic sensor units 20, 30. Accordingly, in some embodiments, the collaboration platform 12 enables a user or other entity requesting a seismic data product or service to see how variations in the required spacing or density of the seismic sensor units 20, 30 may affect the timing of the seismic survey due to the constraints this places on the speed of the deployment vessel 24 and firing rate. The deployment path may also be provided as a configuration parameter.

The way the node resources are to be managed may also be specified in the request or determined from other information provided in the request in some embodiments. For example, OBNs 20 are relatively expensive and so, to manage the node resource to reduce the number of nodes which are needed to survey an area, some nodes 20 may be dropped and then lifted after part of the area has been surveyed and moved to a new position in a new area to be surveyed so that the complete area to be surveyed is covered in stages. In this case, the request may include one or more rolling nodal deployment configuration parameter for configuring a rolling nodal functional building block of a planning and/or deployment workflow component.

The planning workflow component 48 may determine based on a configuration parameter indicating a rolling nodal deployment is to be implemented in the request and one or more other constraints such as the number of available nodes and how long they will take to deploy and be later retrieved after that node deployment area has been surveyed in a rolling node deployment, one or more survey characteristics such as how much area is to be covered per day, how much time to allocate to recharging any OBNs 20 after they are retrieved and before they are redeployed. All this may be taken into account to determine how many deployments would be required and how many shots per day will be required to complete the survey and provide the requested seismic data product or seismic data service.

These are examples of configuration parameters for a planning workflow component 48 which may include in its output the cost as a function of the configuration of that planning workflow component, for example, for a fixed survey configuration how many shots per day (from air-gun), how many nodes per day, and how many days surface vessels will be utilized, will all affect the survey cost.

In some embodiments, the seismic data product or service comprises a seismic imaging data product or seismic imaging data service which may be processed via process/image data stage workflow 40 as shown in FIGS. 3A and 3B. In some other embodiments, however, the collaboration platform 12 may not directly generate a seismic image, instead it may be used to create seismic imaging data which is often used to create seismic images by other seismic data processing entities.

In some embodiments of the collaboration platform 12, however, a survey deliverable or output 44 for a requested survey may include as part of the requested seismic data product or seismic data service a seismic image request. One or more characteristics of the seismic image may be included in the request such, as for example, a type of seismic image, whether the seismic image is a 3D or 4D image (providing coverage over time), the area or volume of the seismic image and its geographic location, and/or the resolution of the seismic image. For example, this may enable the survey requesting entity or other user or other third party 42 to be provided with a “quick look” or low resolution image as a deliverable seismic data product and/or as part of a seismic data service which uses the collaboration platform.

In some embodiments of the collaboration platform 12, the engagement portal 34 comprises a machine to machine data interface. This enables a request to be generated by an external planning workflow component, for example, a system or tool which has been configured to work collaboratively with the collaboration platform 12 in some embodiments. This may allow the collaboration platform 12 to provide data such as, for example, seismic data product or seismic data service to run on a system 42 hosted by a third party in some embodiments such as is shown in FIG. 3A.

In some embodiments, executing the generated workflow comprises acquiring data for the requested seismic data product or service and generating the requested seismic data product or service using the acquired data.

In some embodiments, at least one workflow component comprises a recorder workflow component 56 comprising one or more functional building blocks configured to associate reflected acoustic data captured by a seismic sensor unit with a source of the acoustic data. In some embodiments the source data includes a data source signature for the source and the recorder includes a functional building block configured to perform an integrity check on a source signature as part of the executed end-to-end workflow.

An acoustic source data set will include information about the source sound frequency and time-stamp. The source or acoustic signal emitter creates the acoustic signal and a receiving seismic sensor unit in a OBN for example may capture the emitted acoustic signal and may record it locally.

In some embodiments of the collaboration platform, the seismic sensor units comprise ocean bottom nodes comprising one or more seismic sensor units. In some embodiments, autonomous ocean bottom nodes 20 are used by the collaboration platform which include at least an internal battery, data storage, one or more processors, and at least one hydrophone and at least three geophones. For example, a OBN 20 may be a node using Magseis Fairfield MASS I or MASS III node technology or Z node technology and/or another type of Magseis Fairfield marine seismic node technology in some embodiments. In other embodiments, other types of node may be used. Nodes of different types and versions may be used in the same survey in some embodiments.

FIG. 3B shows another example embodiment of a collaboration platform 12 according to the disclosed technology. In FIG. 3B, an additional post-processing module 60 is shown which receives seismic image data from a image processing workflow module 40. In some embodiments of the example collaboration platform shown in FIG. 3B, the collaboration platform is also configured to output the seismic survey data to an end-user via output module 44. Output module 44 may be configured by an administrator and/or a configuring user or another user to provide access to decision data via the output module 44 in some embodiments of the collaboration platform 12, depending on how the seismic survey has been configured to be delivered the platform.

It is also possible, in some embodiments, for one or more users other than a collaboration platform administrator to configure access rights for one or more other users to one or more modules or data domains used by the collaboration platform 12. This allows such users to access the data generated by the various workflow modules and/or to arrange for data to be input/uploaded to the collaboration platform so that one or more workflow modules can use the input/uploaded data in some embodiments.

In the example embodiments illustrated schematically in FIGS. 3A and 3B of the collaboration platform, a user may use the data assurance workflow component 58 to validate that sensor data recorded by a node is within expected parameter bounds for example or that it has a suitable format for use by other collaboration platform system components and/or modules. As shown in FIG. 3B, the validation data output by the data assurance workflow component 58 may be used by the post-processing module 60 when a user is assessing seismic image data vie the engagement portal 34 or via a third party platform 42. Making this type of information available to downstream users such as a user of server 42 enables such users to be aware of which nodes 20, 30 may be providing data which is not as expected. This allows such user's to decide, or alternatively, they may be informed by the collaboration platform to not use data from a particular a node so that the quality of the seismic data products generated are better optimised and/or so such end-users can optimise their seismic data processing workflows.

In some embodiments, the collaboration platform 12 may be able to configure node deployment and/or retrieval in some embodiments by interfacing with the systems used for such activities, for example, to configure node density and placement.

In some embodiments, the collaboration platform may be able to obtain access data from an ocean flow node network 22 as shown in FIG. 3B, for to access the raw data obtained from such nodes.

Advantageously, some embodiments of the collaboration platform 12 provide access not just to the end-data product which is a seismic survey, but also to data which is used to build the end-data product. This building block data may be raw data or an intermediate data product which is a processed version of the raw data. For example, one type of intermediate data product may comprise raw data collected by each node participating in the survey which is held in a data recorder. Another type of intermediate data product may comprise data formed by calibrating the raw data. Another type of intermediate data product may comprise calibrated data which has been processed to remove one or more errors or data outliers etc., etc. By providing end-users who receive a seismic survey with access to one or more intermediate data products or to the raw data itself, the end-users can recalibrate the seismic survey data they receive and/or process it in different ways from the ways they may be able to process if they did not have access to the raw/intermediate data. For example, they may be able to reformat the raw data to a form which allows different types of preprocessing/post-processing to occur. This may, for example, allow the data to be stored in a more compressed form in some embodiments and/or use fewer computational resources than would be possible otherwise. By providing visibility of one or more data formats of the raw/intermediate processed data used to build a seismic survey, one or more characteristics of the seismic data may be detected or verified which might not otherwise be possible. This may allow for example, improvements in sensitivity and/or accuracy of the final seismic survey data. It may also provide visibility of technical data which otherwise would not be visible. Other measurements may also be acquired during the course of the survey, such as ROV position etc.

The measurement and other data, which is referred to as survey meta-data in some embodiments, may be associated with the seismic survey data in various forms, for example, seismic survey data which is initially in the form captured by nodes, in other words, the raw sensor data in some embodiments. In some embodiments, instead or in addition survey meta data may be associated with pre-processed or part-processed sensor data. In some embodiments, instead or in addition meta data may be associated with the seismic imaging data generated by processing sensor data in some embodiments.

By associating such survey meta-data with the seismic survey data in some embodiments and allowing one or more users to access and/or analyze the survey meta-data via the collaboration platform along with the seismic survey imagining data in some embodiments, it may be possible to use the survey meta data to better understand the seismic survey imaging data. For example, outliers and anomalies detected in the seismic survey data may be associated with specific data sources, for example, individual seismic survey units may be identifiable based on the data they have generated. In this way, if a node detected in this manner is found to be not performing as would be normally expected or otherwise malfunctioning, its data may be excluded from any data-lake generated by the seismic survey so that the seismic data quality can be improved.

For example, in some embodiments, by determining based on the survey metadata that a node is generating anomalous data, if the node is determined to be malfunctioning the data it generates may be excluded or given a low weighting when generating seismic imaging data.

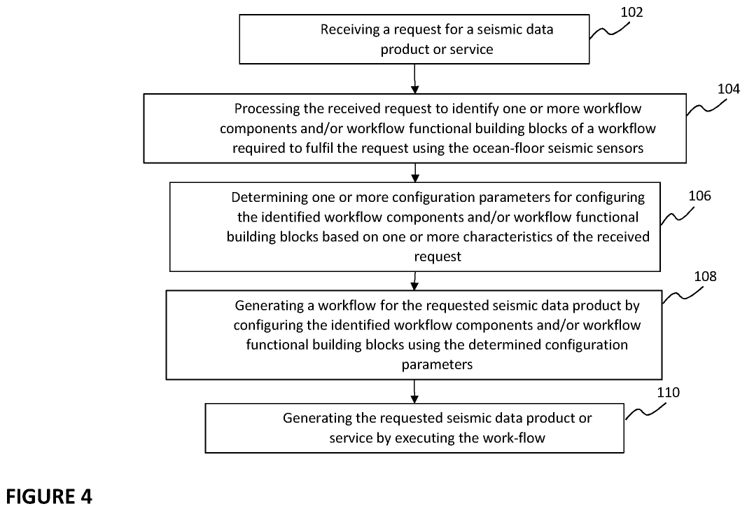

FIG. 4 shows an example of a method or computer-implemented method of manufacturing a seismic data product or seismic data service using seismic sensor units, the method comprising, at a collaboration platform according to any of the disclosed embodiments, receiving 102 a request for a seismic data product or seismic data service; processing 104 the received request to identify one or more workflow components such as, for example, any of the workflow components 48 to 58 shown in FIG. 3A, each workflow component comprising one or more configurable and/or reconfigurable functional building blocks of a workflow required to fulfil the request using the seismic sensor units, determining 106 one or more configuration parameters for configuring the identified functional building blocks based on one or more characteristics of the received request, generating 108 a workflow for the requested seismic data product by configuring the identified workflow components or functional building blocks using the determined configuration parameters and generating 110 the requested seismic data product or service by executing the work-flow, wherein execution of the workflow includes retrieving data from one or more data sources including the seismic sensor units.

In some embodiments, the seismic sensor units include ocean bottom nodes and/or seismic sensor units attached to streamers.

In some embodiments of the method executing the workflow comprises configuring a planning workflow to deploy or redeploy an ocean-bottom array or network of nodes comprising seismic sensors.

In some embodiments of the collaboration system 10 shown in FIG. 1, the collaboration system 10 comprises a system for manufacturing a seismic data product or service. For example, the collaboration system may comprise an ocean-floor network of nodes comprising seismic sensors and a collaboration platform according to any one of the disclosed aspects or embodiments.

In some embodiments, the collaboration system 10 includes a collaboration platform 12 hosted by an apparatus such as the example apparatus 190 of FIG. 5.

As shown schematically in FIG. 5, in some embodiments the apparatus comprises at least a memory 156, one or more processor(s) or controller(s) 152. Computer program code may be held in the memory 156. The computer program code may comprise one or more controller modules 180 and/or workflow component modules 182a comprising code which when executed by the apparatus 190 causes the apparatus 190 to execute one or more of the component workflows 136 to 146 shown in FIGS. 3A or 3B. In some embodiments accordingly, the apparatus 190 comprises one or more processors or controllers 152, for example, a CPU and a GPU, which may be configured to work with one or more collaboration platform controllers 162. The one or more collaboration platform controllers 162 are configured to control directly or indirectly the components 46-58 which each comprise a functional building block of data flow for generating a seismic survey work product using the collaboration system 10. By loading computer program code comprising one or more of the modules shown in FIG. 5 as modules 172-182c, such as, for example, the controller module(s) 180, workflow component module(s) 182, and any workflow application(s) 186 held in the memory 156.

By executing the computer code of the modules 172-182c and/or application code such as application code for the workflows 186a and/or any other application(s) 186b the apparatus 90 may be configured as an embodiment of a configuration platform 10 as disclosed herein and/or the apparatus 90 may be configured to execute a method according to any of the method embodiments of the disclosed technology.

In addition, as shown by way of example in the schematic drawing of the computer code in FIG. 5, code modules may be provided which when executed implement an operating system 172 on the apparats 190 for example. In addition, code modules may be provided which when loaded from memory 156 and executed using one or more processor(s) or processing circuitry 152 of the apparatus 190 cause one or more of a communications module 176, a graphics processing module 178, a controller module 180, and one more collaboration platform modules (182b) as well as the workflow component modules (182a) to be executed in some embodiments of the disclosed technology.

In some embodiments, the computer program code may also include code to implement one or more other code module (82c).

In some example embodiments of the apparatus 190, the memory 156 also stores-as collaboration platform module(s) 182b or as one or other types of modules, a module configured to receive a request for a seismic data product or seismic data service, a module configured to process the received request to identify one or more workflows components comprising one or more configurable functional building blocks for executing a seismic survey or part of a seismic survey to fulfil the request using the seismic sensor units; a module configured to determine one or more configuration parameters for configuring the one or more configurable functional building blocks of at least one identified workflow, a module configured to generate a workflow for the requested seismic data product or seismic data service by configuring the identified building blocks using the determined configuration parameters; and a module configured to execute the work-flow, wherein execution of the workflow includes retrieving data from one or more data sources including the seismic sensors, wherein execution of the workflow generates the requested seismic data product or seismic data service. The modules held in memory 156 may comprises software code or be implemented by executing circuitry, in other words they may comprise hard-coded code components in some embodiments.

As shown schematically in FIG. 5, the apparatus 190 may comprise other components which would be apparent to any one of ordinary skill in the art, for example, a power system 148 may be provided, a data interface 150 for sending and/or receiving data, for example, via the engagement portal shown in FIG. 3A. Suitable communications components indicated as TX/RX/RF circuitry 154 and/or a communications module shown as Comms Module 174 in FIG. 5 may also be provided along with an input/output module 176 to allow the apparatus 190 to communicate with other systems, devices and/or platforms of the collaboration platform and survey equipment. A display controller 162 may be provided in some embodiments to cause images to be presented on a suitable internal or external display 164. One or more other applications 186b may also be held in the memory 156 of the apparatus 190 in some embodiments.

In some embodiments, the apparatus 190 hosts the entire collaboration platform 12 however, in some embodiments, the collaboration platform 12 may be implemented as a distributed system on uses a plurality of intermittently and/or permanently connected hosts. The apparatus may also include or be connectable to connected to additional components such as a display 164 and if so, may include an appropriate controller 162 for the display as would be apparent to any one of ordinary skill in the art. Some embodiments of the apparatus hosting the collaboration platform include collaboration platform component controllers 162 which may be configured to control internal and/or external components or systems 168 which are used to configure one or more or all of: a seismic survey, process data, and/or generate the seismic survey data deliverables. In some embodiments, the collaboration platform 12 may configure and/or control the operation of components configured to do one or more or all of the following: deploy and retrieve nodes, obtain data from the nodes comprising seismic data and/or meta data, process the data to form a data deliverable for outputting from or provided with access to via the collaboration platform 12. For example, one or more processors may comprise graphics processing units, GPUs, may be configured using the platform to process data or a subset of such data to generate a seismic survey image as a data deliverable in some embodiments.

The data which is used to generate such a deliverable may be accessible or outputtable via the collaboration platform to a user in some embodiments, and may in some embodiments a data deliverable may be provided with other data so that anomalies (including errors) can be more easily detected using an appropriate technique and flagged for additional processing. In some embodiments, anomalies may be detectable by processing a data deliverable using a suitable artificial intelligence, Al, or machine learning, ML, technique. In some such embodiments, an internal or external system processing the data deliverable may be configured to automatically send requests via the system for additional processing.

The collaboration apparatus 12 may be configured in some embodiments with one or more data interfaces to external systems or tools, wherein the external systems or tools are configured to contribute to the delivery of the product or service.

In some embodiments of apparatus 190, the memory 156 includes a computer program product which, when executed on the apparatus 190 causes the apparatus 190 to implement the computer-implemented method of producing a seismic data product or seismic data service using seismic sensor units according to any one of the disclosed aspects or embodiments disclosed herein.

In some embodiments one of the collaboration platforms modules may be configured to enable a request generated by a survey instructing entity to be received by the collaboration platform 12 via engagement portal 26. The engagement portal 26 may be provided in the form of an interactive desktop portal in some embodiments that allows the customer to monitor progress and provide operational oversight throughout the project execution.

In some embodiments, a user of the engagement portal is able to configure and obtain status updates from each of the component workflows used to obtain the requested seismic data product or service. A request may be a request generated during the design and/or planning stage of a seismic survey or later.

A request may be received via the engagement portal 26 using a user interface or automatically generated within a workflow of the user or another party using the collaboration system. For example, if the survey generates seismic imaging data as a deliverable, this may be delivered to a third party for processing into a seismic image, and in some embodiments, both the third party and the party originating the survey request may be able to monitor the status of the survey workflows 46 to 58. In other words, a request may be a request for a seismic image data product from a customer or from an image interpreter. In some embodiments of the apparatus 190, the apparatus comprises a collaboration platform in which the data interface(s) 150 shown in FIG. 5 comprises one or more data interfaces to external systems or tools. For example, the data interface(s) 150 may be configured in some embodiments so that one or more external systems or tools which are configured to contribute to the delivery of a seismic data product or service provided by the apparatus 190 are able to share data including control data with the apparatus 190.

Although in the above description the component workflows 46 to 58 comprise functional blocks configured to execute functions associated with the design, planning, source, receiver, navigation, recorder stages of a seismic survey, particularly a marine seismic survey, other workflow components may be used by the assembled workflow and/or one or more of these workflow components may be omitted or performed in a different order or repeated. Other examples of workflows may include workflows differently targeting the seismic survey mobilization, deployment, acquisition, recovery demobilization, data management, data processing, and interpretation stages.

Some embodiments of the disclosed technology provide a workflow management collaboration platform 12 which allows a number of entities to federate their data so that it is visible and usable by other entities when configuring a seismic data survey. Advantageously, this allows two or more parties to collaboratively engage in planning a seismic survey using the collaboration platform by sharing control over how the workflow modules and module components are configured.

By allowing access to raw data and to other intermediate data products, it is possible, for example to do one or more of the following: significantly reduce the efforts needed by crew personnel offshore, standardize seismic data deliverables, automate the generation of required node analysis images, automate the generation of a final node report including all relevant data and automate all analysis of meta data for node verification. Some embodiments of the collaboration platform 12 also support automated analysis of seismic data needed for node Go/No-Go flagging and allow users to add sub-set data outputs needed for on-board processing, OBP, analysis of suspect nodes, as well as to add automated meta data spooling. This enables other efficiency projects as well as operational oversight(s). The collaboration platform can also be used to flag data recovery/repair for problem nodes and be used for first break picking for receiver position refinement. Some embodiments of the collaboration platform also support source system integration.

The collaboration platform may also support implementation of the following tasks in some embodiments: standardized data deliverables, for example, by implementing SEGY 1.1 output from both recording system and WKG, importing MSFF standard SPS pre-plan header so that missing project information such as (i.e. magnetic declination, projection, etc.) can be added. In addition it allows other types of missing information, for example, information missing from the shot and/or receiver table deliverables to be added.

The collaboration platform may be used in some embodiments to generate final node reports for output, for example, reports which include all images generated by the seismic survey, one or more or all attribute window(s), all node meta data (self-test results, meta data analysis, etc.), one or more or all survey statistics, for example the survey, runtime, shot coverage.

The collaboration platform in some embodiments may be used to process the survey data by applying data rotation, auto-determining the in-line correction angle including magnetic corrections automatically rather than using a user-entered correction angle based on the magnetic and in-line corrections. In addition some embodiments of the collaboration platform allow timing correction(s) to be applied to the seismic data, for example, the platform may allow in some embodiments, complete implementation of a correction algorithm.

In addition, some embodiments of the collaboration platform 12 allow user analysis/visualize of generated images and may allow user(s) to also flag problems in any images analyzed by switching operational modes to allow a user to move from merely observing a seismic image to an interactive mode where a user is able to use a quality check, QC, plot.

The disclosed technology provides various technical benefits, for example, the platform may provide one or more benefits such as standardized data deliverables, reduce the time before node(s) are re-deployed, allow quicker evaluation of results of deployments, allow for a reduction in required user time, improve problem analysis, reduce the time to analyze anomalies.

Some embodiments of the disclosed technology may also allow analysis of calculated values in which the values derived from one node can be compared to adjacent nodes. This may, for example, allow for better anomaly detection. Some embodiments of the disclosed technology may provide a data subset output capability, for example, allowing a user to configure the collaboration platform 12 to generate output 44 which allows OBP analysis either on or off shore.

Some embodiments of the disclosed technology provide rotation analysis of sensor date which allows the directionality of horizontal component energy to be determined using a suitable technology. This type of analysis can also be used to flag ianomalous nodes in some embodiments. In some other embodiments, the collaboration platform can be used to perform analysis on rotations in-line/cross-line which may be used to perform, analysis residual energy on horizontals and this may also be used to flag anomalous nodes.

Some embodiments of the disclosed technology may be used to perform meta data spooling where, for example, background meta data spooling is performed to add this type of data to the data lake generated in a seismic data survey.

Some embodiments may also provide technical advantages as they can support automated go/no go flags for data images using RMS and rotation for example. By only evaluating flagged nodes, a crew on board a vessel does not need to interact with as many nodes as they would have if they needed to interact with all deployed nodes. Moreover, by processing the data on-board using the collaboration platform, more data can be discarded and the resulting reduction in data sets generated onboard reduces the amount of data that is required to be provided or transmitted to on-shore data lakes/stores.

By automating meta-data spooling to a data store such as a date lake, shore based monitoring of projects can be facilitated off-line, and in near real-time in some embodiments as the data is retrieved from nodes. This allows more data analytics to be performed as data analysis tasks can be shared between an on-board and off-board crew. In some embodiments, if all deliverables from the node recording system are made available, sub-sets of data may allow for anomalous nodes to be corrected on-shore. Alternatively, even if all data is still handled by an on-board processing, OBP, team, by allowing subsets of data to be generated which are configured, for example, in some embodiments using the collaboration platform 12, the amount of time to process a data set can be greatly reduced.

Accordingly, in some embodiments, the collaboration platform is provided as part of a user-configurable seismic survey system for performing a seismic survey. The user-configurable seismic survey system comprises a plurality of seismic sensor units, one or more deployment and/or retrieval systems for deploying and retrieving the plurality of seismic sensor units, for example, ROVs or AOVs may be used in conjunction with surface or submerged vessels in some embodiments to place nodes on the ocean bottom or similar marine environment, and also comprises a seismic survey collaboration platform such as the seismic survey collaboration platform 12 described herein. The collaboration platform 12 is user-configurable in some embodiments to cause the seismic sensor units to generate seismic sensor data, receive seismic sensor data directly or indirectly from a subset or all of the seismic sensor units, process a subset or all of the received seismic sensor data to form at least one seismic sensor image of the seismic survey, wherein the at least one seismic sensor image is associated by the collaboration platform with at least part of the received seismic sensor data and/or survey meta-data for the at least part of the received seismic sensor data associated with the at least one seismic sensor image data; and output or provide access to a seismic survey data product or service comprising the at least one seismic sensor image and at least part of the received seismic sensor data and/or survey metadata to one or more users of the collaboration system.

For example, in some example embodiments, when seismic data is obtained from a retrieved node, the raw sensor data may be processed first by performing a geophone rotation which then generates SEG-Y rotated continuous data which can be accessed by a user via the collaboration system 12. In some embodiments, the shot data for the sensor survey is verified and/or validated and appropriate clock corrects are then applied to the data retrieved from the nodes. After the clock corrections have been applied, field shot and receiver tables can be generated, and SEG-Y data comprising rotated clock and corrected shot sliced data can be accessed by a user via the collaboration platform. If the user accepts the rotated and clock drift corrected data, they may fully access, review and/or use the data quality checks, QCs, for the seismic survey data product/service. Such QCs include a measurement QC, a receiver amplitude QC, a receiver gather (near IL/XL shots) QC, a position/timing QC, and a node rotation QC. The QC data is generated by the recorder system in some embodiments. In some embodiments, node QC logs may be generated by a user of the collaboration system to identify potential issues for pre-applied clock drift corrections or geophone rotation. The SEG-Y rotated clock corrected shot sliced data may then be sent from or made accessible via the collaboration platform 12 in some embodiments.

In some embodiments, of the user-configurable seismic survey system, at least one of the one or more users receiving the output or provided with access to the seismic survey data product is a user who has used the collaboration platform to configure the seismic survey.

In some embodiments, the collaboration platform 12 may be accessed via one or more users, at the same or different times and used to configure a seismic survey. One or more or all of the users may interact with the collaboration platform and input or upload request data to the collaboration platform. By way of example, such request data may comprises a request for a seismic data product or seismic data service generated using the collaboration platform which is sent to or enter into the collaboration platform. Once the request has been received, the collaboration platform processes the received request to identify one or more workflow components comprising one or more configurable functional building blocks for executing the seismic survey or a part of the seismic survey to fulfil the request using the seismic sensor units, determines one or more configuration parameters for configuring the one or more configurable functional building blocks of at least one identified workflow, generates a workflow for the requested seismic data product or seismic data service by configuring the identified building blocks using the determined configuration parameters, and executing the work-flow by retrieving data from one or more data sources including data from seismic sensors of the seismic sensor units to generate the requested seismic survey imaging data product or service.

In some embodiments, the seismic sensor units are located on or above or are embedded in any suitable type of environment where seismic signals may be detected. For example, a lake-bed or a river-bed or other bottom or an open body of water, a sea floor, an ocean bottom, any other suitable type of marine environment. Alternatively, or in addition, sensor units may be deployed in a land environment, which may be a subterranean environment in some embodiments, such as for example, in a cave, mine, pit or shaft or the like or which may be a land-surface environment. The sensors may also be deployed in any other environment including, for example, manufacturing environments, which may generate seismic data for seismic surveys. As mentioned above, by way of example only in some embodiments, the collaboration data deliverables may include trace differential, for example, SEG-Y, continuous data, SEG-Y shot sliced data, a recorder shot table, a recorder receiver table, and a node quality check, QC, log. Such data deliverables may be delivered on tape and flash drives and/or delivered via a network attached system such as an external drive in some embodiments.

In the drawings and specification, there have been disclosed various examples of embodiments of the disclosed embodiments. However, many variations and modifications can be made to these embodiments. Accordingly, although specific terms are employed, they are used in a generic and descriptive sense only and not for purposes of limitation, the scope of the embodiments being defined by the following claims.

1-34. (canceled)

35. An apparatus for interactively generating user-customised end-to-end workflows which to provide seismic data products and/or seismic data services using seismic sensor units, the platform comprising:
an engagement portal for a user to generate a request for a seismic data product and/or service, wherein the request comprises configuration parameters and values for one or more or all of a plurality of workflow components forming an end-to-end workflow, the plurality of workflow components comprising a design workflow component, a planning workflow component, a source workflow component, a receiver workflow component, a navigation workflow component, a recorder workflow component, and a data assurance workflow component;
at least one module configured to receive, via the engagement portal, the request for a seismic data product or seismic data service;
at least one module configured to process the received request to identify one or more workflow components comprising one or more configurable functional building blocks for generating the user-customised end-to-end workflow for executing a seismic survey or part of a seismic survey to fulfil the request using the seismic sensor units;
at least one module configured to determine one or more configuration parameters for configuring the one or more configurable functional building blocks of at least one identified workflow component of the end-to-end workflow;
at least one module configured to generate the user-customised end-to-end workflow for the requested seismic data product or seismic data service by configuring the identified building blocks using the determined configuration parameters; and
at least one module configured to execute the user-customised end-to-end work-flow, wherein execution of the user-customised end-to-end workflow includes retrieving data from one or more data sources including the seismic sensors, wherein execution of the workflow generates the requested seismic data product or seismic data service,
wherein the engagement portal is further configured to allow end-users to interactively engage with the design, planning, source, receiver, navigation, recorder and data assurance stage workflow components of the end-to-end workflow.

36. The apparatus of claim 35, wherein at least one configurable functional building block includes a control interface and a data interface via which the functional building block may be interrogated and/or configured using control information and/or configuration parameters provided in a subsequent request associated with the received request, wherein a subsequent request comprises a request for a seismic data product or seismic data service which comprises a seismic survey workflow status update, wherein the collaboration platform is configured to respond to the request by interrogating one or more workflow components to obtain workflow status update information and shares the workflow status update information with the entity from which the subsequent request originated.

37. The apparatus of claim 35, wherein at least one workflow component comprises a recorder workflow component comprising one or more functional building blocks configured to:
associate acoustic data captured by a seismic sensor unit with data capable of providing a data source signature, wherein at least one functional building block of the recorder workflow is configured to perform an integrity check on the source signature as part of the executed workflow.

38. The apparatus of claim 35, the apparatus being configured to cause the deployment of seismic sensor units, and the retrieval of seismic sensor units.

39. The apparatus of claim 35, wherein the apparatus is to configure seismic sensor unit density and placement.

40. The apparatus of claim 35, further comprising a plurality of seismic sensor units.

41. The apparatus of claim 35, the apparatus being configured to automatically adjust the seismic sensor unit density.

42. The apparatus of claim 35, wherein the request comprises configuration parameters and values for a plurality of the workflow components, the apparatus being configured to determine one or more configuration parameters for configuring the one or more configurable functional building blocks for the plurality of workflow components.

43. The apparatus of claim 42, wherein the request comprises configuration parameters and values for all of the workflow components.

44. The apparatus of claim 35, wherein the apparatus causes seismic sensor units to operate to generate seismic sensor data; receive seismic sensor data directly or indirectly from a subset or all of the seismic sensor units; and process a subset or all of the received seismic sensor data to form at least one seismic sensor image.

45. The apparatus of claim 44, wherein the apparatus is to configure at least one of: an amount of shots, a timing of the shots, and a frequency of shots fired.

46. The apparatus of claim 45, wherein the apparatus is configured to verify shot data.

47. The apparatus of claim 46, configured to perform a quality control check at the completion of each source line and wherein the apparatus verifies the shot data if the quality is determined to be acceptable.

48. The apparatus of claim 36, wherein the status update is a seismic sensor unit deployment and/or retrieval status update, and wherein the apparatus is configured to adjust the deployment and/or retrieval operation parameters.

49. The apparatus of claim 35, wherein the apparatus is configured to validate sensor data recorded by a seismic sensor unit to determine whether the sensor data is within expected parameter bounds.

50. The apparatus of claim 35, the apparatus being configured to perform a seismic sensor unit verification and quality control check, the apparatus being configured to allow graphic processing of seismic sensor data to start following completion of the seismic sensor unit verification and quality control check.

51. The apparatus of claim 35, the apparatus configured to provide, to the user, raw or intermediate data, the raw or intermediate data comprising at least one of:
raw data collected by each seismic sensor unit;
data formed by calibrating the raw data;
calibrated data which has been processed to remove one or more errors or data outliers.

52. The apparatus of claim 35, the apparatus being configured to determine whether a seismic sensor unit is generating anomalous data based on metadata.

53. The apparatus of claim 52, wherein, if the seismic sensor unit is determined to be malfunctioning, the apparatus is configured to exclude data from that seismic sensor unit, or assign it a weighting, when generating seismic imaging data.

54. An apparatus for interactively generating user-customised end-to-end workflows which to provide seismic data products and/or seismic data services using seismic sensor units, the apparatus comprising:
an engagement portal for a user to generate a request for a seismic data product and/or service, wherein the request comprises configuration parameters and values for a design workflow component the design workflow component to configure at least one of: a total area to be surveyed and the depth of each planned survey, how long will the planned survey be conducted for, how big is the area to be covered with each seismic sensor deployment, for example, if the area planned to be surveyed using a node roll technique or not, and if so, the size of each node roll, the size of the total area, the location of the survey, the type of outputs required from the collaboration survey, for example, the resolution of any requested imaging data and/or image to be generated from the data,
a planning workflow component to configure at least one of: how many nodes will be required to provide the requested output, what density of nodes may be required, for example, a higher node density may result in a higher image resolution, if the acoustic signal sources are known, how the seismic sensor units should be positioned, and one or more other characteristics of the survey operation,
at least one module configured to receive, via the engagement portal, the request for a seismic data product or seismic data service;
at least one module configured to process the received request to identify one or more workflow components comprising one or more configurable functional building blocks for generating the user-customised end-to-end workflow for executing a seismic survey or part of a seismic survey to fulfil the request using the seismic sensor units;
at least one module configured to determine one or more configuration parameters for configuring the one or more configurable functional building blocks of at least one identified workflow component of the end-to-end workflow;
at least one module configured to generate the user-customised end-to-end workflow for the requested seismic data product or seismic data service by configuring the identified building blocks using the determined configuration parameters; and
at least one module configured to execute the user-customised end-to-end work-flow, wherein execution of the user-customised end-to-end workflow includes retrieving data from one or more data sources including the seismic sensors, wherein execution of the workflow generates the requested seismic data product or seismic data service, wherein the engagement portal is further configured to allow end-users to interactively engage with the design, planning, source, receiver, navigation, recorder and data assurance stage workflow components of the end-to-end workflow, and
a collaboration platform being configured to interface with a system to configure node density and placement, the collaboration platform being configured to cause the seismic sensor units to generate seismic sensor data, receive seismic sensor data directly or indirectly from a subset or all of the seismic sensor units, process a subset or all of the received seismic sensor data to form at least one seismic sensor image of the seismic survey.
